(19) United States
(12) Patent Application Publication
(10) Pub. No.: US 2026/0181405 A1
(43) Pub. Date: Jun. 25, 2026

(54) CONFIGURING A WIRELESS NETWORK USING SYNTHETIC WIRELESS TRAFFIC DATA

(71) Applicant: Dell Products L.P., Round Rock, TX (US)

(72) Inventors: Jeebak Mitra, Ottawa (CA); Yahya Saad Abbas, Montréal (QC)

(21) Appl. No.: 18/990,858

(22) Filed: Dec. 20, 2024

(51) Int. Cl. H04W 16/22; G06N 3/0475; G06N 3/09; H04W 24/06

(52) U.S. Cl. CPC H04W 16/22; G06N 3/0475; G06N 3/09; H04W 24/06

(57) ABSTRACT

The technologies described herein are generally directed toward using differential checkpoints to generate synthetic wireless traffic data. For instance, a system can obtain training data based on a time series data representation generated based on measured wireless traffic in a wireless coverage area. The system can further, based on the training data and an output of a discriminator, train a generator to generate synthetic wireless traffic data, resulting in a trained generator. Further, the system can, based on an output of the generator, train the discriminator to detect the synthetic wireless traffic data, with a generative adversarial network being deployed for the wireless coverage area that may include the generator and the discriminator.

### BACKGROUND

Modern approaches to configuring wireless networks may utilize configurations that change constantly. Coverage area location, time, date, and other conditions may all be used in combination to adjust network parameters. In different implementations, different approaches are used to predict how wireless activity will be distributed in a coverage area.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include obtaining, by a system comprising one or more processors, training data based on a time series data representation generated based on measured wireless traffic in a wireless coverage area. The example method may further include, based on the training data and an output of a discriminator, training, by the system, a generator to generate synthetic wireless traffic data, resulting in a trained generator. Further, the example method may include, based on an output of the generator, training, by the system, the discriminator to detect the synthetic wireless traffic data, with a generative adversarial network being deployed for the wireless coverage area that may include the generator and the discriminator.

In additional or alternative embodiments, the training of the generator may include training the generator to generate the synthetic wireless traffic data usable for prediction of future wireless traffic for the wireless coverage area. In additional or alternative embodiments, the method may further include, in response to the synthetic wireless traffic data being generated by the trained generator, outputting, by the system, the synthetic wireless traffic data. In additional or alternative embodiments, the method may further include, before the outputting, upsampling, by the system, the synthetic wireless traffic data that was generated by the trained generator, resulting in upsampled synthetic wireless traffic data that may be usable for prediction of wireless traffic for another wireless coverage area that may be larger than the wireless coverage area. In additional or alternative embodiments, the method may further include, prior to the outputting of the synthetic wireless traffic data, filtering, by the system, the synthetic wireless traffic data based on a spatiotemporal filter.

In additional or alternative embodiments, the method may further include, before the training of the generator, extracting, by the system, at least some of the training data corresponding to a selected feature resulting in extracted training data, and the extracting may include applying a convolutional operator to the training data, and the generator training may be further based on the extracted training data. In additional or alternative embodiments, the training data may include initial training data, and with a first granularity applicable to the extracted training data being different than a second granularity applicable to the initial training data. In additional or alternative embodiments, the generative adversarial network may include a conditional generative adversarial network, and training of the generator based on the training data may include training the generator based on respective training data labeled with respective measurement time labels.

In additional or alternative embodiments, the training of the discriminator may be based on at least one difference between at least one label applied by the discriminator to at least one output of the generator and at least one true label of the at least one output, with the at least one difference being determined based on at least one focal loss determined based on the at least one label and the at least one true label. In additional or alternative embodiments, the generative adversarial network may include a conditional generative adversarial network, and the training of the generator based on the training data may include training the generator based on training data that was filtered to include a micro-cluster part of the wireless coverage area.

In additional or alternative embodiments, the training of the generator to generate the synthetic wireless traffic data may include applying a basis expansion vector to respective training data, with the basis expansion vector being generated based on a characteristic of a selected pattern of wireless network traffic applicable to the micro-cluster part. In additional or alternative embodiments, the characteristic may include a spatiotemporal characteristic. In additional or alternative embodiments, the spatiotemporal characteristic may include a coverage area of a base station at a selected time. In additional or alternative embodiments, the characteristic may include an operator behavior characteristic.

An example system can operate as follows. At least one memory may store computer executable instructions, and at least one processor may be configured to process the computer executable instructions that, when executed by the at least one processor, facilitate performance of operations. The operations may include communicating, to a machine learning system, wireless data corresponding to measured wireless activity over a defined period of time in a geographic area. The operations may further include communicating, to the machine learning system, a selected pattern of wireless activity corresponding to the geographic area. Further, the operations may include receiving, from the machine learning system, predictive wireless activity data, with the machine learning system generating the predictive wireless activity data based on a generative machine learning model that was trained based on the wireless data and the selected pattern.

In additional or alternative embodiments, the machine learning system utilized a basis expansion vector based on the selected pattern, to customize the predictive wireless activity data based on the selective pattern. In additional or alternative embodiments, the operations may further include communicating, to the machine learning system, filter data corresponding to a filter, with the predictive wireless activity data being based on the generative machine learning model that was trained by the wireless data as filtered by the filter data.

An example non-transitory machine-readable medium may include executable instructions that, when executed by at least one processor, facilitate performance of operations. The operations may include receiving a request, from a network configuration system, comprising a time period and a behavior pattern. The operations may further include, based on a learning dataset of collected coverage area data of a radio area network coverage area, manipulating respective weights of a generative model, resulting in a configured generative model that may be configured to produce generated coverage area data. Further the operations may include generating a feature mapping vector matrix based on the behavior pattern, with the manipulating of the respective weights being based the feature mapping vector matrix. The operations may further include filtering the generated coverage area data based on a time period, resulting in filtered coverage data. The operations may further include based on the request, communicating the filtered coverage data to the network configuration system.

In additional or alternative embodiments, the filtering may be further based on coverage area data collected within a portion of the radio area network coverage area. In additional or alternative embodiments, the portion of the radio area network coverage area may include a coverage area where collected data has been processed to conform to the behavior pattern.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate generating wireless network traffic data, in accordance with one or more embodiments;

FIG. 2 is an architecture diagram of an example system that can facilitate generating wireless network traffic data, in accordance with one or more embodiments;

FIG. 3 includes a diagram of an example system that can facilitate generating wireless network traffic data, in accordance with one or more embodiments;

FIG. 4 includes a diagram of an example system that can facilitate adjusting the granularity of data used to generate wireless network traffic data, in accordance with one or more embodiments;

FIG. 5 includes a diagram of an example system that can facilitate generating wireless network traffic data that may be specific to micro-clusters of activity, in accordance with one or more embodiments;

FIG. 6 depicts a flow diagram representing example operations of an example method that can facilitate generating wireless network traffic data, in accordance with one or more embodiments;

FIG. 7 depicts an example system that can facilitate generating wireless network traffic data, in accordance with one or more embodiments;

FIG. 8 depicts an example non-transitory machine-readable medium that can include executable instructions that, when executed by a processor of a system, can facilitate generating wireless network traffic data, in accordance with one or more embodiments;

FIG. 9 is a schematic block diagram of a system with which the disclosed subject matter can interact; and

FIG. 10 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the performance, accuracy, efficiency, and specificity of a computing system that implements and/or otherwise configures components of a wireless network, can be improved, e.g., by providing approaches to increase the amount of useful, predictive data that allows networks to be pre-configured for different conditions, while preserving or improving the performance and efficiency of network configuration systems. One or more embodiments described herein provide solutions to problems associated with training a machine learning model based on sparse amounts of blended wireless traffic data. These problems become especially complex when large complex networks serving populations are sought to be pre-adjusted and pre-configured to handle different traffic conditions. Further, it is noted that implementations described herein can provide solutions to technical problems that are inextricably tied to computer systems. For example, approaches are described that can generate synthetic wireless traffic data that is useful for both large coverage areas and microclusters of activity within coverage areas, rapidly adjusting different synthesizing parameters based on the likelihood of accuracy, the diversity of traffic condition to be modeled, and other conditions that can affect embodiments. As described below, embodiments described herein utilize approaches that solve these and other technical problems with technical solutions. Moreover, implementations described herein can provide these solutions in a manner that cannot reliably be performed by a human or even a plurality of humans, e.g., generating predictive wireless traffic data for diverse and ever-changing combinations of wireless network conditions, without compromising other considerations, such as computation time and efficiency.

In general, network management systems, in an effort to be proactive rather than reactive to network events, often use traffic forecasting by leveraging various network traffic data. One or more embodiments described herein can generate synthetic wireless traffic data for a coverage grid, while utilizing, as compared to other approaches, less data as input, and less storage for the trained model. In some implementations, the selected coverage grid may correspond to coverage areas of one or more base stations, and the synthetic wireless traffic data may be representative of an underlying transmission environment, e.g., using time and geographic coordinates as labels.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

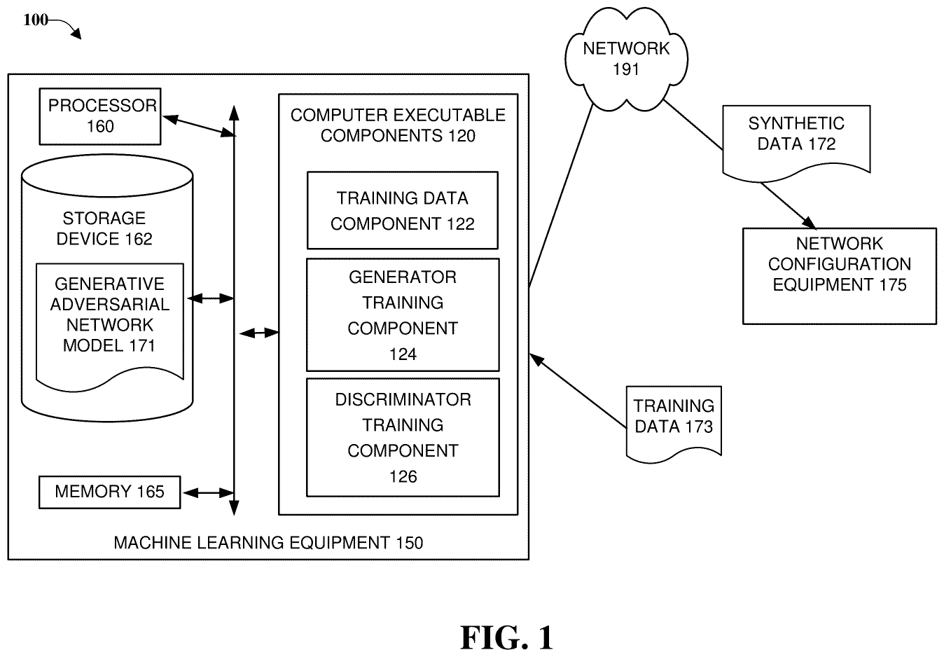

FIG. 1 is an architecture diagram of an example system 100 that can facilitate generating wireless network traffic data, in accordance with one or more embodiments. For purposes of brevity, description of like elements and/or processes employed in other embodiments is omitted. As depicted, system 100 includes machine learning equipment 150 connected, via network 191, to network configuration equipment 175.

Wireless traffic used to follow a somewhat general daily variation pattern in which the time of day was often the predominant factor, e.g., low traffic in the very early morning, increasing throughout the morning and afternoon to a peak in the mid-evening, and then dropping throughout the night back to the very early morning low. This was sufficient when the base stations were designed based on the maximum expected traffic levels, without considering traffic variations. However, in modern networks, the dynamic nature of user behavior and the impact of external factors, including the characteristics of the deployment scenario, can cause vast differences in a cell site's traffic during weekdays and weekends, holidays, and large gatherings, for example. Further, more contemporary base stations can adapt their resource usage (modify their incremental capacity to match throughput) and corresponding power consumption dynamically, whereby unnecessary overprovisioning of the resources can be mitigated, compared to base stations designed based on peak capacity only. Thus, accurate traffic forecasting in modern networks for an upcoming duration (e.g., a short duration such as the next half-hour) based on at least some measured traffic data may be useful for network configuration. Additionally, having accurate traffic forecasting that incorporates patterns (e.g., trends) based on relatively recent traffic variations may also be useful.

As described herein, the traffic level prediction for an upcoming timeframe can be based on recently collected traffic statistics. However, the traffic level prediction can also be based on longer term historical information related to traffic demand that the given cell site experiences (temporal correlation), such as what was measured last year, last month, last week, yesterday and so on. Further, as described herein, in some situations due to relative proximity, a traffic predictor for a base station may use more recent and/or longer term historical traffic information of the base station's neighboring sites as well, that is, leveraging spatial correlation data, when available and appropriately relevant.

As described herein, generating predictive, synthetic wireless traffic data for an upcoming timeframe can be based on recently collected traffic statistics and measured wireless signals. However, the traffic level prediction can also be based on longer term historical information about measured wireless traffic signal activity such as what was measured last year, last month, last week, yesterday and so on.

As depicted, machine learning equipment 150 can include memory 165 that can store one or more computer and/or machine readable, writable, and/or executable components 120 and/or instructions. In embodiments, machine learning equipment 150 can further include processor 160. In one or more embodiments, computer executable components 120, when executed by processor 160, can facilitate performance of operations defined by the executable component(s) and/or instruction(s). Computer executable components 120 can include training data component 122, generator training component 124, discriminator training component 126, and other components described or suggested by different embodiments described herein, that can improve the operation of system 100. Machine learning equipment 150 may further include storage device 162. In an example, storage device 162 may provide nonvolatile storage of data, data structures, computer executable instructions, and so forth, e.g., storage device 162 is depicted as storing generative adversarial network model 171. It is appreciated that generative adversarial network model 171 may also be stored in volatile memory, such as memory 165.

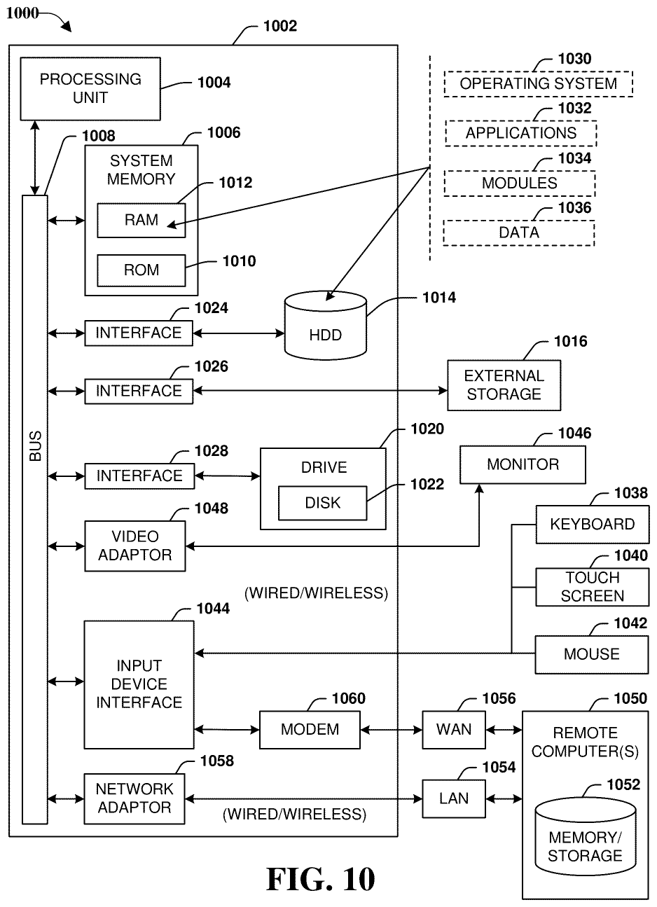

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of training data component 122, which can in some implementations can obtain training data based on a time series data representation generated based on measured wireless traffic in a wireless coverage area. For example, in one or more embodiments, training data component 122 may obtain training data 173 based on a time series data representation generated based on measured wireless traffic in a wireless coverage area.

In another example, memory 165 can store executable instructions that can facilitate generation of generator training component 124, which in some implementations may, based on the training data and an output of a discriminator, train, by the system, a generator to generate synthetic wireless traffic data, resulting in a trained generator. For example, in one or more embodiments, generator training component 124 can, based on training data 173 and an output of a discriminator, train generative adversarial network model 171 to generate synthetic data 172, resulting in a trained generator.

In another example, memory 165 can store executable instructions that can facilitate generation of discriminator training component 126, which in some implementations may, based on an output of the generator, train the discriminator to detect the synthetic wireless traffic data, with a generative adversarial network being deployed for the wireless coverage area that includes the generator and the discriminator. For example, in one or more embodiments, discriminator training component 126 may, based on an output of generator training component 124, train a discriminator of generative adversarial network model 171 to detect synthetic wireless traffic data, with generative adversarial network model 171 being deployed for the wireless coverage area that comprises the generator and the discriminator.

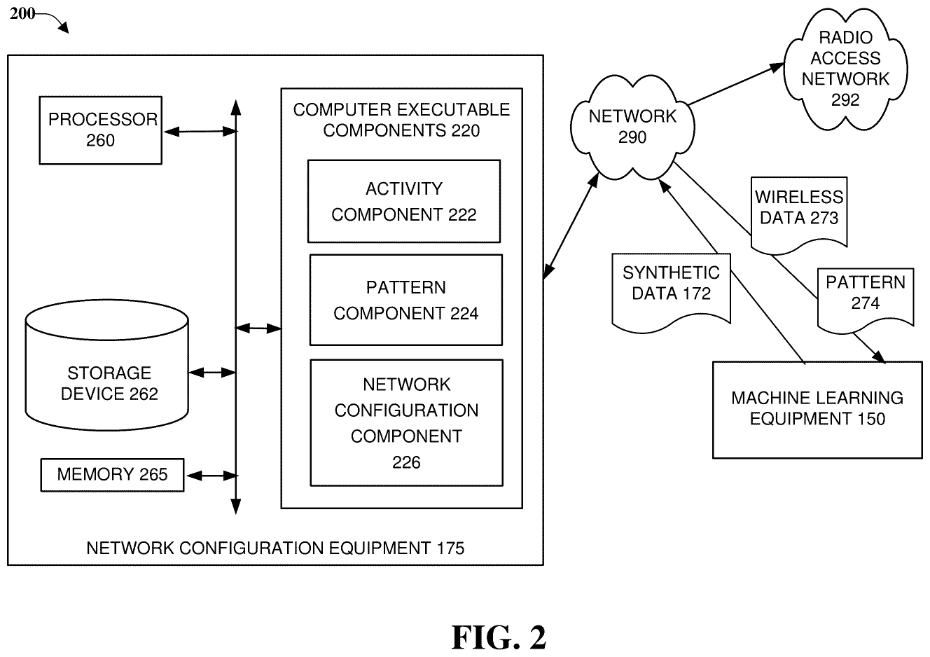

It should be noted that machine learning equipment 150, network configuration equipment 175, and other devices discussed herein, can execute code instructions that may operate on servers or systems, remote data centers, or ‘on-box’ in individual client information handling systems, according to various embodiments described herein. In some embodiments, it is understood any or all implementations of one or more embodiments described herein can operate on a plurality of computers, collectively referred to as machine learning equipment 150. For example, one or more of the functions of machine learning equipment 150, and network configuration equipment 175, can all be implemented as separate subsystems running in the kernel of a computing device as well as operating on separate network equipment, e.g., as depicted in FIGS. 1 and 2.

FIG. 2 is an architecture diagram of an example system 200 that can facilitate generating wireless network traffic data, in accordance with one or more embodiments. For purposes of brevity, description of like elements and/or processes employed in other embodiments is omitted. As depicted, system 200 includes network configuration equipment 175 connected, via network 290, to machine learning equipment 150 and radio access network (RAN) 292. Network configuration equipment 175 includes processor 260, memory 265, storage device 262, and computer executable components 220.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include activity component 222, pattern component 224, network configuration component 226, and other components described or suggested by different embodiments described herein, e.g., that can improve the operation of system 200, in accordance with one or more embodiments.

As discussed further with FIG. 10 below, network 290 and RAN 292 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2(3GPP2 ) ultra-mobile broadband (UMB), fifth generation core (5G Core), fifth generation option 3× (5G Option 3×), high speed packet access (HSPA), Z-Wave, Zigbee and other 802.XX wireless technologies and/or legacy telecommunication technologies.

In an example implementation of network configuration equipment 175, memory 265 can store executable instructions that can facilitate generation of activity component 222, which in some implementations, may communicate, to a machine learning system, wireless data corresponding to measured wireless activity over a defined period of time in a geographic area. For example, one or more embodiments, activity component 222 may communicate to machine learning equipment 150, wireless data 273 corresponding to measured wireless activity of RAN 292 over a defined period of time in a geographic area.

In an example implementation of network configuration equipment 175, memory 265 can further store executable instructions that can facilitate generation of pattern component 224, which in some implementations, may communicate, to the machine learning system, a selected pattern of wireless activity corresponding to the geographic area. For example, in one or more embodiments, pattern component 224 may communicate to machine learning equipment 150, pattern 274 of wireless activity corresponding to a geographic area of RAN 292.

In an example implementation of network configuration equipment 175, memory 265 can further store executable instructions that can facilitate generation of network configuration component 226, which in some implementations, may receive, from the machine learning system, predictive wireless activity data, wherein the machine learning system generated the predictive wireless activity data based on a generative machine learning model that was trained based on the wireless data and the selected pattern. For example, in one or more embodiments, network configuration component 226 may receive from machine learning equipment 150, synthetic data 172 (e.g., predictive wireless activity data), with machine learning equipment 150 generating synthetic data 172 by employing generative adversarial network model 171 that was trained by generator training component 124 based on wireless data 273 and pattern 274.

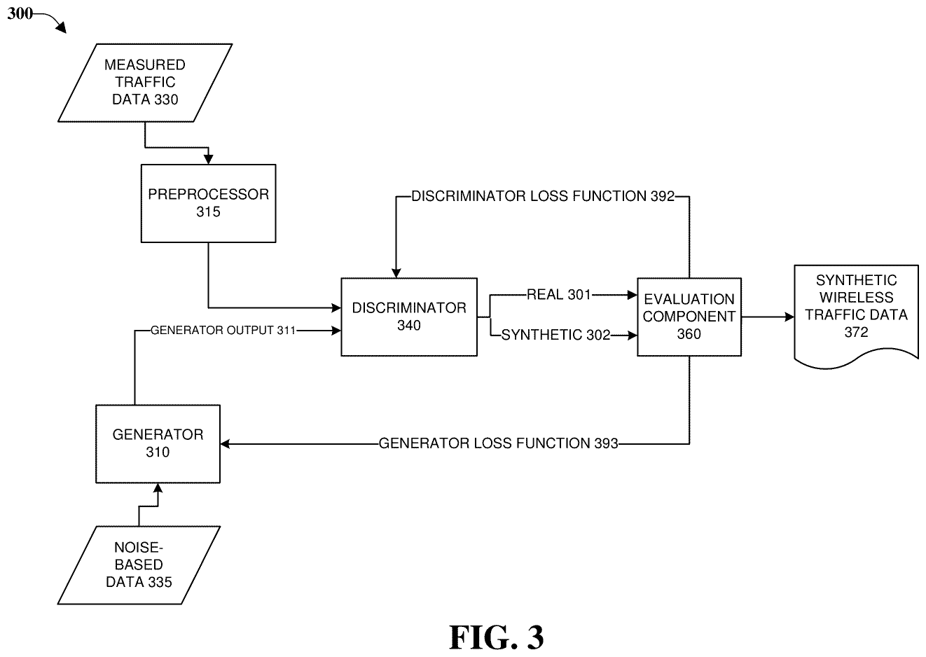

FIG. 3 includes a diagram of an example system 300 that can facilitate generating wireless network traffic data, in accordance with one or more embodiments. For purposes of brevity, description of like elements and/or processes employed in other embodiments is omitted. System 300 includes components of an example processing flow of a conditional generative adversarial network that may be employed by embodiments. System 300 includes preprocessor 315, generator 310, discriminator 340, and evaluation component 360. Preprocessor 315 receives measured traffic data 330, generator 310 receives noise-based data 335, discriminator 340 produces labeled results to evaluation component 360 which produces synthetic wireless traffic data 372.

A high-level diagram of the basic processing flow of the ML-architecture of a conditional generative adversarial network that may be utilized by embodiments is shown in FIG. 2. The two building blocks are the generator 310 and discriminator 340. Measured traffic data 330 is provided as one of the inputs to preprocessor 315, e.g., including one or more data pipelines that may handle aspects such as incomplete data, out of order data and the like. Additionally, preprocessing operations may include, but are not limited to, known preprocessing operations that clean data with respect, readily apparent outliers suggestive of equipment or measuring errors, missing data, and so forth. More particularly, known data preparation techniques (which is done regardless of the type of machine learning model to be trained) can be used to compensate for random blanks, incorrectly captured data, numerical errors, outliers, gaps, incomplete data and so on. Note that if spatiotemporal data from one or more neighboring sites is available, such data can also be used for data completion; (note however that the use of such spatiotemporal data is not limited to filling in missing data, but can also be used as a source of feature data as described herein). Preprocessor 315 passes data to generator 310.

Also providing data to discriminator 340, generator 310 receives random noise (e.g., Gaussian distributed) as an input and uses a machine learning data model to provide generator output 311 to discriminator 340. In one or more embodiments, discriminator 340 may operate as a binary classifier to distinguish between real 301 and synthetic 302 output provided by measured traffic data 330 and generator 310, respectively. In an embodiment, discriminator 340 provides a probability that respective input to discriminator is real 301.

In implementations, operating in the conditional generative adversarial network, evaluation component 360 may function as a convergence evaluation block that uses a loss function to analyze a disparity of the generator output 311 to measured traffic data 330. In one or more embodiments, to evaluate the difference between the truth and the probability output of discriminator 340, one or more embodiments may employ a focal loss analysis, which may be represented by the following, which adds a tunable term to cross-entropy analysis:

$$F = - {( 1 - {p}_{x} )}^{γ} log ( {p}_{x} )$$

In the above, (F) is the focal loss, which can, in some implementations, adjust the determined cross-entropy loss (log (pₓ)) based on the combination of the predicted probability (pₓ) output from discriminator 340 and a focusing parameter (γ). In one or more embodiments, changing the focal parameter may increase the contribution of misclassified or uncertain examples (e.g., relatively low (pₓ) to the overall gradient during training, while reducing the contribution from well-classified examples. In some circumstances, because wireless traffic data may have a large class imbalance, adjusting focal loss based on an estimated class imbalance may provide more useful results.

In embodiments, this loss function value may be provided back to discriminator 340 as discriminator loss function 392. This loss function value may also be fed back to generator 310 as generator loss function 393, e.g., to update the set of weights of the machine learning data model.

One or more embodiments can output from evaluation component 360, synthetic wireless traffic data for a two-dimensional coverage grid, e.g., corresponding to coverage areas of one or more base stations. Combinations of different approaches described herein may synthesize data that captures the diurnal and hourly variations of data in a spatiotemporal distribution.

It should be noted that the technology described herein works with any machine learning model that can be trained on multiple features. Thus, for example, the model can include but is not limited to, a recurrent neural network model, a convolutional neural network model, a long-term short-term model, a feed forward network model, a graph neural network model, or a recursive neural network model.

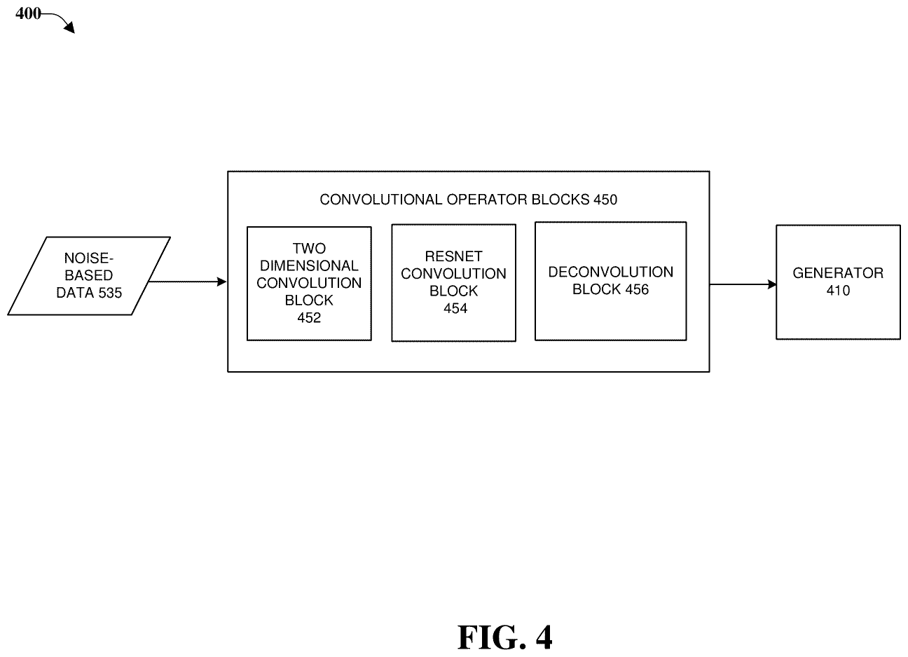

FIG. 4 includes a diagram of an example system 400 that can facilitate adjusting the granularity of data used to generate wireless network traffic data, in accordance with one or more embodiments. For purposes of brevity, description of like elements and/or processes employed in other embodiments is omitted. System 500 includes noise-based data 535, convolutional operator blocks 450, which include two-dimensional convolution block 452, residual network (ResNet) convolution block 454, and deconvolution block 456. In an embodiment, rather than using the noise-based data 535 at the level of granularity provided, generator 410 may uses convolutional operators to do feature extraction, which may allow for reduction in storage requirements, e.g., by employing one or more of convolutional operator blocks 450.

In an embodiment, two-dimensional convolution block 452 includes layers that contain an activation function layer that uses rectified linear units (ReLU). In an embodiment, ResNet convolution block 454 may include three layers, e.g., a convolution layer, a batch normalization layer, and an ReLU activation function layer, all of which are two-dimensional. In some implementations, ResNet convolution block 454 may capture the different features in detail and generate the input for deconvolution block 456.

In embodiments, deconvolution block 456 may invert the operation of other convolutional operator blocks 450, e.g., to expand the input data determined by the other convolutional operator blocks 450, essentially upsampling the input to generator 410 to a selected granularity level.

Based on convolutional operator blocks 450 and other operations described herein, generator 410 may generate output from input data that includes both normal random numbers and random numbers with a target time label. Generator 410 may also be tuned by employing mean squared error (MSE) for the loss function described with discriminator 340 in FIG. 3. Further to this discrimination stage, discriminator 340 may include an instance of two-dimensional convolution block 452, and a two-dimensional batch normalization block followed by a leaky ReLU block.

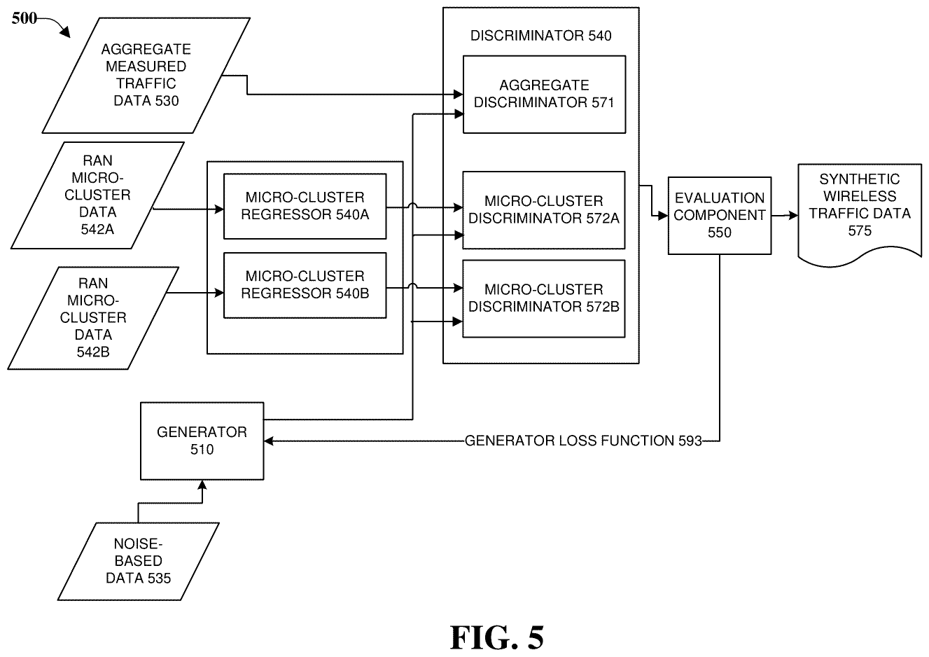

FIG. 5 includes a diagram of an example system 500 that can facilitate generating wireless network traffic data that may be specific to micro-clusters of activity, in accordance with one or more embodiments. For purposes of brevity, description of like elements and/or processes employed in other embodiments is omitted. System 500 includes components of an example generative adversarial network with micro-cluster data processing, e.g., generator 510, discriminator 540 (including aggregate discriminator 571 and micro-cluster discriminators 572A-B), micro-cluster regressors 540A-B, and evaluation component 550.

One or more embodiments of system 500 may generate synthetic wireless traffic data 575 that is specific to micro-clusters of the overall coverage area. In embodiments, having synthetic data that describes smaller clusters of users within the coverage area of one or more base stations, may help to identify micro-patterns of activity. Example micro-clusters include, but are not limited to, areas around a sports center on game day, a cluster of office buildings at lunchtime, and an entertainment district at night. In some implementations, movement and usage (e.g., “behavior”) of individual wireless devices may exhibit clustering characteristics, with the co-location of devices with different traffic usage behaviors.

Expanding on conditional-GAN embodiments described with FIG. 3, in system 500, RAN micro-cluster data 542A-B can be modeled as a class for input to discriminator 540, and processing by micro-cluster discriminators 572A-B, respectively. Aggregate discriminator 571 receives aggregate measured traffic data 530 and generator 510, which receives noise-based data 535 and generator loss function data 593. Micro-cluster regressors 540A-B, receive RAN micro-cluster data 542A-B. Micro-cluster discriminators 572A-B of discriminator 540 receive data from micro-cluster regressors 540A-B, respectively, and generator 510.

In an embodiment, to separate out the micro-cluster patterns of RAN micro-cluster data 542A-B, micro-cluster regressors 540A-B may employ selected basis expansion vectors that enable the capture micro-cluster behavior at a smaller granularity compared to the macro behavior of aggregate discriminator 571 and aggregate measured traffic data 530.

Micro-cluster regressors 540A-B perform basis expansion on RAN micro-cluster data 542A-B, resulting in the element-wise products of the generated traffic patterns being processed by respective discriminators 572A-B. Discriminator 540 thus provides to evaluation component 550, a discrimination result that includes probabilities of the input traffic being synthetic, and belonging to each micro-cluster. Evaluation component 550 thus may produce synthetic wireless traffic data 575 that is specific to micro-clusters of the overall coverage area.

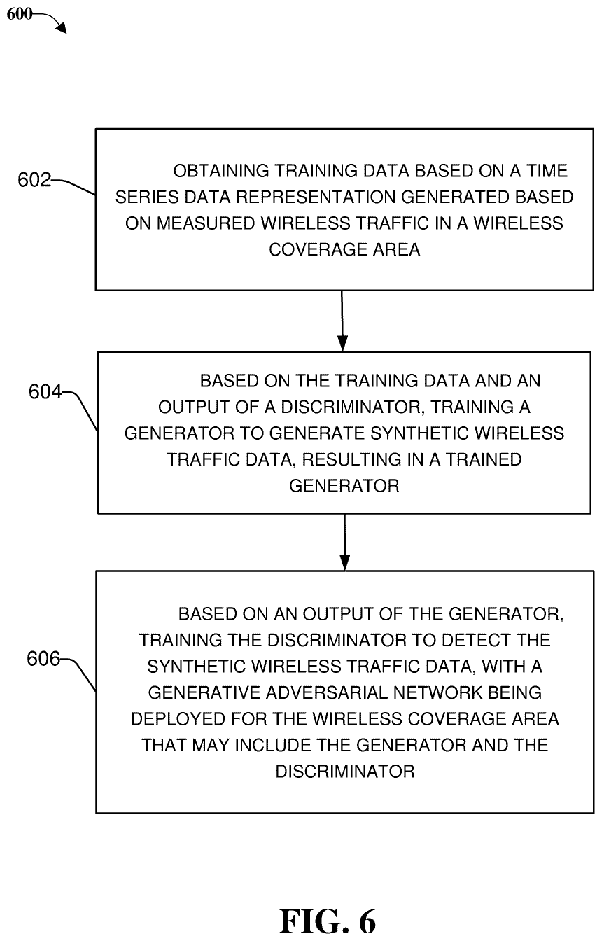

FIG. 6 depicts a flow diagram representing example operations of an example method 600 that can facilitate generating wireless network traffic data, in accordance with one or more embodiments. For purposes of brevity, description of like elements and/or processes employed in other embodiments is omitted.

In some examples, one or more embodiments of method 600 can be implemented by training data component 122, generator training component 124, discriminator training component 126, and other components that can be used to implement aspects of method 600, in accordance with one or more embodiments. FIG. 6, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 602 of method 600, training data component 122 of machine learning equipment 150 can obtain training data based on a time series data representation generated based on measured wireless traffic in a wireless coverage area. At 604 of method 600, generator training component 124 can, based on the training data and an output of a discriminator, train a generator to generate synthetic wireless traffic data, resulting in a trained generator. At 606 of method 600, discriminator training component 126 can, based on an output of the generator, train the discriminator to detect the synthetic wireless traffic data, with a generative adversarial network being deployed for the wireless coverage area that may include the generator and the discriminator.

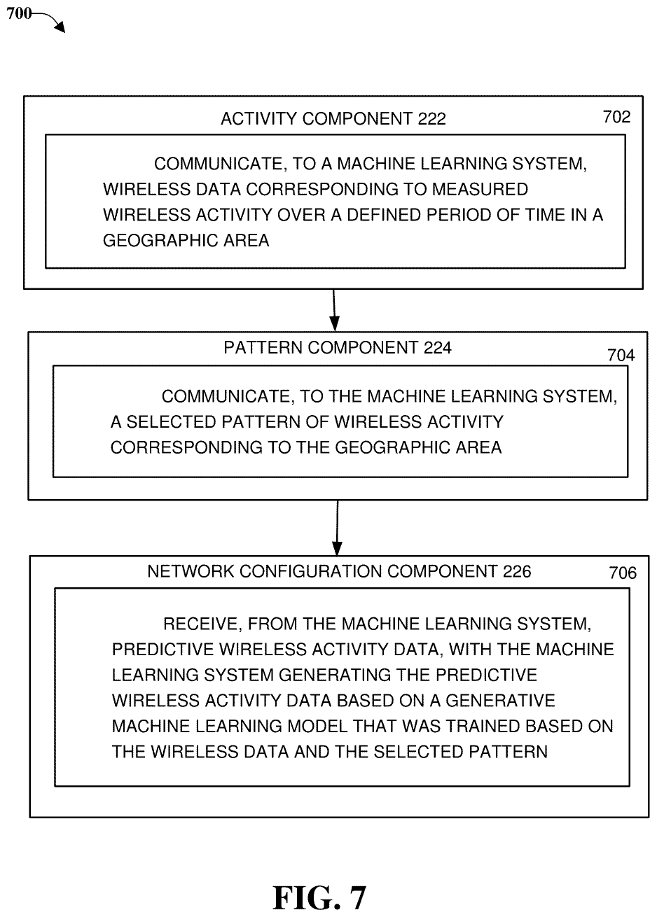

FIG. 7 depicts an example system 700 that can facilitate generating wireless network traffic data, in accordance with one or more embodiments. For purposes of brevity, description of like elements and/or processes employed in other embodiments is omitted.

Example system 700 can include activity component 222, pattern component 224, network configuration component 226, and other components that can be used to implement aspects of system 700, as described herein, in accordance with one or more embodiments.

At 702 of FIG. 7, activity component 222 can communicate, to a machine learning system, wireless data corresponding to measured wireless activity over a defined period of time in a geographic area. At 704 of FIG. 7, generator training component 124 can communicate, to the machine learning system, a selected pattern of wireless activity corresponding to the geographic area. At 706 of FIG. 7, network configuration component 226 can receive, from the machine learning system, predictive wireless activity data, with the machine learning system generating the predictive wireless activity data based on a generative machine learning model that was trained based on the wireless data and the selected pattern.

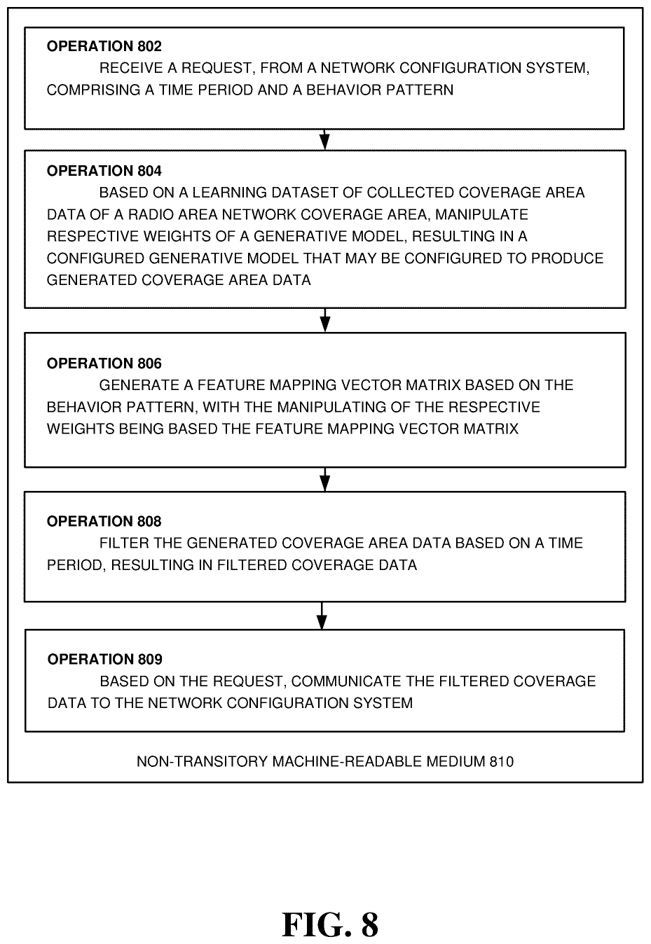

FIG. 8 depicts an example 800 non-transitory machine-readable medium 810 that can include executable instructions that, when executed by a processor of a system, can facilitate generating wireless network traffic data, in accordance with one or more embodiments. For purposes of brevity, description of like elements and/or processes employed in other embodiments is omitted.

As depicted, non-transitory machine-readable medium 810 includes executable instructions that, when executed by at least one processor of a machine learning device, facilitate performance of operations that include operation 802 which can receive a request, from a network configuration system, comprising a time period and a behavior pattern. The operations may further include operation 804 which can, based on a learning dataset of collected coverage area data of a radio area network coverage area, manipulate respective weights of a generative model, resulting in a configured generative model that may be configured to produce generated coverage area data. The operations may further include operation 806 which can generate a feature mapping vector matrix based on the behavior pattern, with the manipulating of the respective weights being based the feature mapping vector matrix.

The operations may further include operation 808 which can filter the generated coverage area data based on a time period, resulting in filtered coverage data. The operations may further include operation 809 which can communicate the filtered coverage data to the network configuration system.

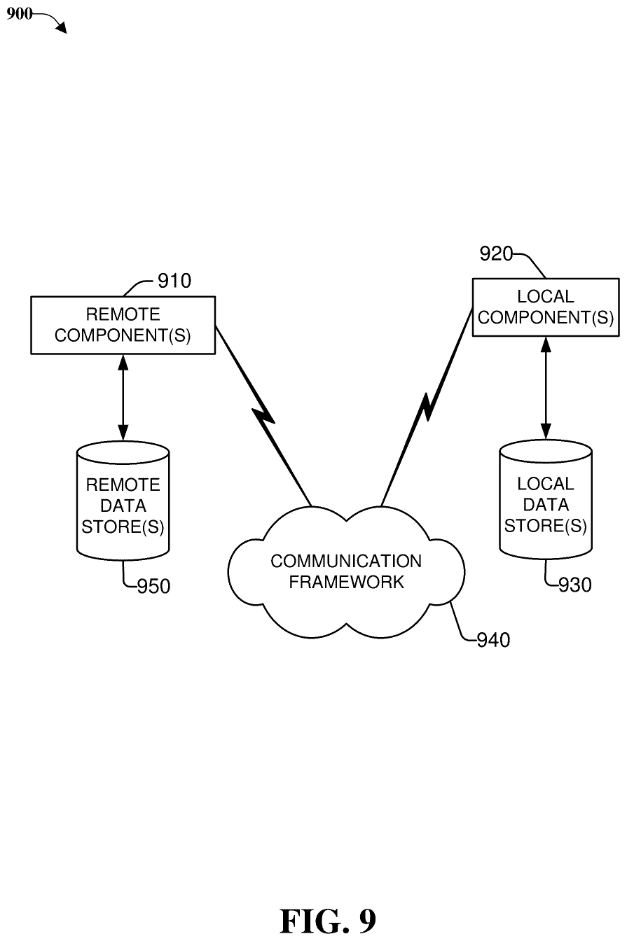

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, RAN devices, gateway devices, femtocell devices, servers, etc. The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in different systems, e.g., both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strip . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2(3GPP2 ) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
obtaining, by a system comprising one or more processors, training data based on a time series data representation generated based on measured wireless traffic in a wireless coverage area;
based on the training data and an output of a discriminator, training, by the system, a generator to generate synthetic wireless traffic data, resulting in a trained generator; and
based on an output of the generator, training, by the system, the discriminator to detect the synthetic wireless traffic data, wherein a generative adversarial network is deployed for the wireless coverage area that comprises the generator and the discriminator.

2. The method of claim 1, wherein the training of the generator comprises training of the generator to generate the synthetic wireless traffic data usable for prediction of future wireless traffic for the wireless coverage area.

3. The method of claim 1, further comprising:
in response to the synthetic wireless traffic data being generated by the trained generator, outputting, by the system, the synthetic wireless traffic data.

4. The method of claim 3, further comprising:
before the outputting, upsampling, by the system, the synthetic wireless traffic data that was generated by the trained generator, resulting in upsampled synthetic wireless traffic data that is usable for prediction of wireless traffic for another wireless coverage area that is larger than the wireless coverage area.

5. The method of claim 3, further comprising, prior to the outputting of the synthetic wireless traffic data, filtering, by the system, the synthetic wireless traffic data based on a spatiotemporal filter.

6. The method of claim 1, further comprising:
before the training of the generator, extracting, by the system, at least some of the training data corresponding to a selected feature resulting in extracted training data, wherein the extracting comprises applying a convolutional operator to the training data, and wherein the training of the generator based on the training data comprises training the generator based on the extracted training data.

7. The method of claim 6, wherein the training data comprises initial training data, and wherein a first granularity applicable to the extracted training data is different than a second granularity applicable to the initial training data.

8. The method of claim 1, wherein the generative adversarial network comprises a conditional generative adversarial network, and wherein the training of the generator based on the training data comprises training the generator based on respective training data labeled with respective measurement time labels.

9. The method of claim 1, wherein the training of the discriminator is based on at least one difference between at least one label applied by the discriminator to at least one output of the generator and at least one true label of the at least one output, and wherein the at least one difference was determined based on at least one focal loss determined based on the at least one label and the at least one true label.

10. The method of claim 1, wherein the generative adversarial network comprises a conditional generative adversarial network, and wherein the training of the generator based on the training data comprises training the generator based on training data that was filtered to comprise a micro-cluster part of the wireless coverage area.

11. The method of claim 10, wherein the training of the generator to generate the synthetic wireless traffic data comprises:
applying a basis expansion vector to respective training data, wherein the basis expansion vector was generated based on a characteristic of a selected pattern of wireless network traffic applicable to the micro-cluster part.

12. The method of claim 11, wherein the characteristic comprises a spatiotemporal characteristic.

13. The method of claim 12, wherein the spatiotemporal characteristic comprises a coverage area of a base station at a selected time.

14. The method of claim 11, wherein the characteristic comprises an operator behavior characteristic.

15. A system, comprising:
at least one processor; and
at least one memory that stores executable instructions that, when executed by the at least one processor, facilitate performance of operations, the operations comprising:
communicating, to a machine learning system, wireless data corresponding to measured wireless activity over a defined period of time in a geographic area,
communicating, to the machine learning system, a selected pattern of wireless activity corresponding to the geographic area, and
receiving, from the machine learning system, predictive wireless activity data, wherein the machine learning system generated the predictive wireless activity data based on a generative machine learning model that was trained based on the wireless data and the selected pattern.

16. The system of claim 15, wherein the machine learning system utilized a basis expansion vector based on the selected pattern, to customize the predictive wireless activity data based on the selective pattern.

17. The system of claim 15, wherein the operations further comprise:
communicating, to the machine learning system, filter data corresponding to a filter, and wherein the predictive wireless activity data is based on the generative machine learning model that was trained by the wireless data as filtered by the filter data.

18. A non-transitory machine-readable medium, comprising executable instructions that, when executed by at least one processor, facilitate performance of operations, the operations comprising:
receiving a request, from a network configuration system, comprising a time period and a behavior pattern;
based on a learning dataset of collected coverage area data of a radio area network coverage area, manipulating respective weights of a generative model, resulting in a configured generative model that is configured to produce generated coverage area data;
generating a feature mapping vector matrix based on the behavior pattern, wherein the manipulating of the respective weights is based the feature mapping vector matrix;
filtering the generated coverage area data based on a time period, resulting in filtered coverage data; and
based on the request, communicating the filtered coverage data to the network configuration system.

19. The non-transitory machine-readable medium of claim 18, wherein the filtering is further based on coverage area data collected within a portion of the radio area network coverage area.

20. The non-transitory machine-readable medium of claim 19, wherein the portion of the radio area network coverage area comprises a coverage area where collected data has been processed to conform to the behavior pattern.
